(19) United States
(12) Patent Application Publication
(10) Pub. No.: US 2009/0153292 A1
(43) Pub. Date: Jun. 18, 2009

(54) BUSINESS AND SOFTWARE SECURITY AND STORAGE METHODS, DEVICES AND APPLICATIONS

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/093,741

(22) PCT Filed: Nov. 13, 2006
(86) PCT No.: PCT/IL06/01304

§ 371 Date: Sep. 8, 2008

Related U.S. Application Data
(60) Provisional application No. 60/738,992, filed on Nov. 23, 2005.

(51) Int. Cl. G05B 19/00; G09G 5/00; G06F 21/00; G06F 17/30; G06F 3/048

(52) U.S. Cl. 340/5.52; 340/5.51; 345/156; 345/647; 726/2; 726/3; 726/6; 707/204; 715/810; 707/E17.001

(57) ABSTRACT

The current invention describes methods and apparatuses for providing improved security for access to networks, on and off the Internet. A series of sign-in options configured according to several parameters prevent several types of automatic hacking. The nature of the choices for access, the method of controlling one's choices, and the method of randomization are new. Devices for applying these options include data-processing units such as computers and cell phones to which these methods are written. Some applications of increased security are online storage solutions, web-based email, and a shopping cart system. One particular combination of these applications that is discussed is the integration of web-based email with online storage for other files as well.

### FIELD AND BACKGROUND OF THE INVENTION

The present invention (building upon a previous provisional patent by the same inventor) relates to improved network security methods that lead to an internet-based access solution, and, more particularly, to a business method of quickly and reliably guaranteeing secure account access and then providing an option to make it even more secure. This solution enables better online storage and email solutions, among others, and the capability to save files from web-based email in the same domain. Here, “network” can refer to a web page or site or even a single person's device containing memory, thereby including, for example, cell phones and PDAs.

The problem of preventing hackers from attacking a site, and particularly the secure portions of it, is a serious and widespread problem. Hackers have developed many tools to automatically break into accounts and steal data and personal information. The current invention is mainly directed towards decreasing the susceptibility to hacking using automated methods such as “brute force” and “dictionary” hacking that are directed against the common user name/password combinations for access security. The present invention may not cure the problem in all its embodiments, but it makes it much harder for hackers to direct such programs to a victim and succeed.

Most Internet and network sites are content to authenticate (secure access) with a user name and password, but these are easily hacked. Secured sites have any of several other methods of securing access, such as biometric devices and special cards, although most still rely on a single user name and password. Even when biometric devices are used, there is still a problem when biometric devices simply store the user name and password, as in the standard Microsoft biometric device. Furthermore, even large corporations with sophisticated security systems may wish to enable employees the choice of logging in securely without the use of access devices such as VPN access.

Many Internet and network sites also use predictable patterns that enable easier hacking.

Some websites such as Yahoo for its Yahoo Groups produce hard-to-read shapes of numbers and letters for users to enter in order to complete the login, but those differ from the current invention, for example, in not providing misleading information to a hacker, in not breaking up a series of steps, not being on separate pages, and so on. (This is known as a “Turing test” and/or “CAPTCHA” (CAPTCHA stands for “completely automated public Turing test to tell computers and humans apart”). Some CAPTCHA techniques may be used by the current invention as part of a set of options for the user.

The CAPTCHA programs are not foolproof. According to http://www.captcha.net/, most have been broken to some extent. Yet the site mentions the idea of using these to prevent dictionary hacking attacks. Such programs are also barriers for the disabled. It would be desirable to have options for the disabled that enable the mixing of interactive and verification steps in order to make hacking their accounts more difficult, or that enable them to choose the type of CAPTCHA program that fits their abilities, rather than having no choice at all.

An application of the authentication problem is the need for many individuals and businesses to have both web-based email and a backup system for important files that is not prone to hacking. The current invention is the first business method to propose storage that integrates web-based email back up with back up of other files. Another use of the current invention is the improvement over the simple user name/password model for accessing bank accounts and shopping cart accounts with online sellers.

Examples of how current providers fail to provide this service follow:

Google has web-based email without related storage space for non-email files.

Yahoo has separate web-based email and separate file storage capacity, but lacks a way to store Yahoo emails in the same folders as other files.

Web-based email is a crucial part of all business records, and the inability to include the email messages in online storage solutions without using a POP3 program, downloading, and uploading again is a deficiency of the current art (unless the company uses a system such as Microsoft Exchange Server, but then the system also has some of the security flaws noted and is not browser-based, and does not save to the user's back up space). The process can be streamlined for the convenience of the customer. In addition, a new method in which web-based email can be conveniently stored in the same folders as other files makes keeping email and other files related to one subject matter convenient to the user. With more secure access, users are more likely to combine web-based email with a storage plan.

Offsite back-up is important for many individuals and businesses. Services offering such back-up sometimes ask for no more than a user name and password.

There is thus a widely recognized need for, and it would be highly advantageous to have, a method of providing quick, online security for access to accounts and to one's data backups. One innovation of the current invention is the method of combining several sign-in steps of different types according to the user's preference.

The present invention successfully addresses the shortcomings of the presently known configurations by providing a system that is less prone to hacking, and enables immediate sign up and use of a website in a highly secure manner. It has applications for use in such areas as online banking, data storage, and e-mail.

### FIGURES

FIG. 1 is a list of some verification and interactive steps.

FIG. 2 is a flow chart of log in steps.

FIG. 3 is a flow chart of log in formatting of entries.

FIG. 4 is a flow chart of an audio or video interactive step.

FIG. 5 is a mock-up of the sign-up and control panel for the first two log in choices.

FIG. 6 is a continuation of a mock-up of the sign-up and control panel for the final log in choices.

FIG. 7 is a picture of how the verification with a biometric device might work.

FIG. 8 is a picture of how an audio interactive step might look.

FIG. 9 is a picture of how a movement interactive step might look.

FIG. 10 is a picture of an interactive deductive question.

FIG. 11 is a mock-up of save settings for an email/storage program.

FIG. 12 is a mock-up of the looping concept.

FIG. 13 is a diagram of the devices involved in the apparatuses described and their relationships to each other and the user.

### DESCRIPTION OF THE DRAWINGS

### Definitions

Verification steps refer to the use of devices, user names, passwords, IP address verification, and other types of entry steps to ensure that only the appropriate person is signing into an account. Verification inputs refer to the information provided in the process of verification of identity and providing of access. In this patent, web site or site is used in a general sense to include access pages on an intranet as well as an Internet or any other display or window shown by a display attached to a data processor, including other data devices, such as cell phones, and network refers to both intranet and Internet, as well as networks for other devices such as cell phones and PDAs. A network may refer to a mere network of one, meaning that the inventions described may apply to setting access to a particular device. The use of a physical device such as a biometric device can be included in the group of verification steps. Verification is used interchangeably with the term identification. Interactive steps refer to the request that a user enter an unfixed (that is, not the same entry each time) response via a data input machine to some information, so they may refer in one embodiment to identifying graphics, which do not verify a person's identity, but which may deter hackers. In other words, the input varies each time the user accesses the page. Some input steps may be in the categories of both validation and interaction; when this occurs, the classification of a validation step would depend upon the user providing information not presented to him on the screen. The terms video and animation are used interchangeably. A submit button refers to any button that enables the user to submit data on a page. Computer is meant to refer to any computerized processor. A user or customer is an administrator when he sets controls for others. A change in the level of security is one that, defined negatively, does more than enable changing of the content of a user name and/or password. Defined positively, a change in the level of security enables the alteration of the susceptibility of a secure site to hacking by changing the difficulty level of the input desired. Examples: Changing one password to another or even the number of characters required does not change the level of security, even if it makes the site more secure. Adding a biometric device or adding the need to interpret a graphic file alters the level of security. It changes the nature of the process of providing input rather than the content alone. Refusing or permitting entry refer to being allowed to the next step in log in, whether that step is the last in the process of logging in or not. Web-based refers to any software using a network based on any kind of browser, so that the term would include a program for accessing email via a personal device or cell phone.

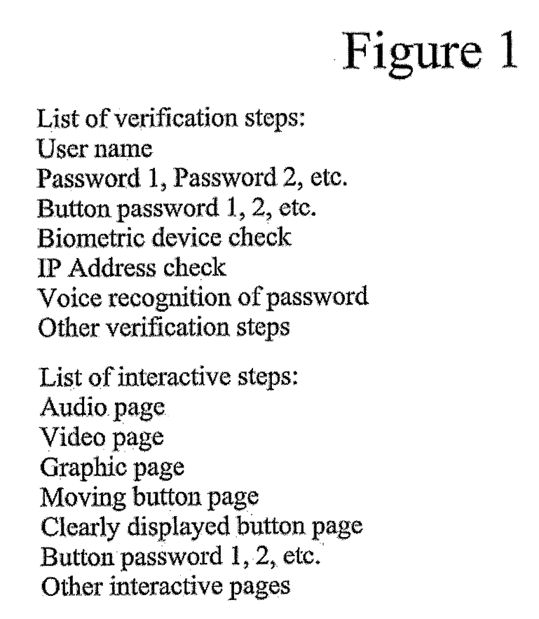

A list of some verification and interactive steps is provided in FIG. 1. (Some verification steps can be interactive as well.) This is a sample, and is not meant to exclude or include any steps in the current invention, and does not necessarily imply that any of those steps are unique to this invention.

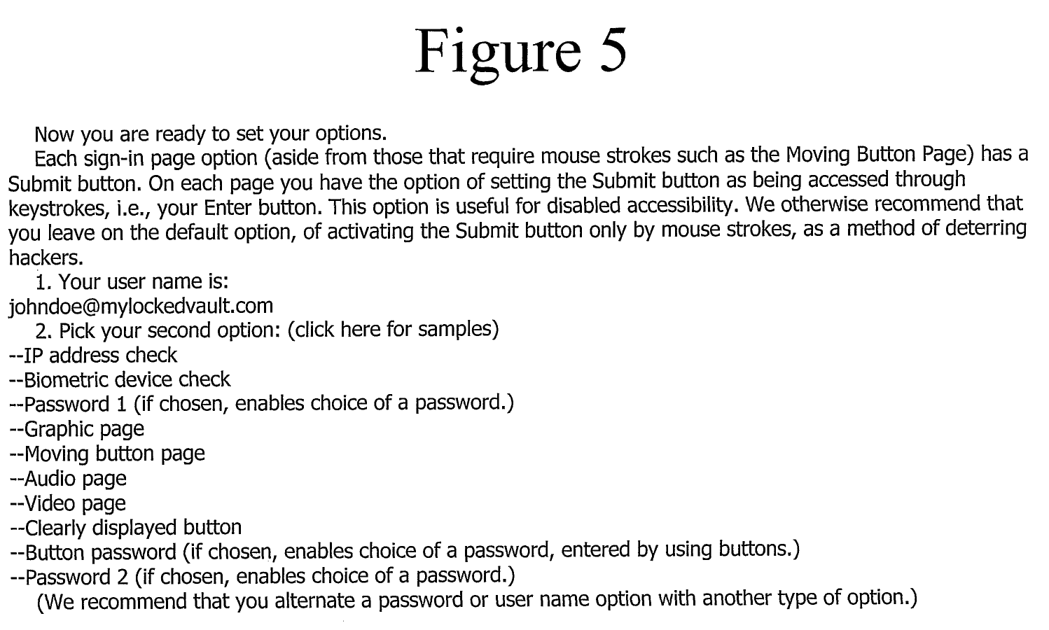

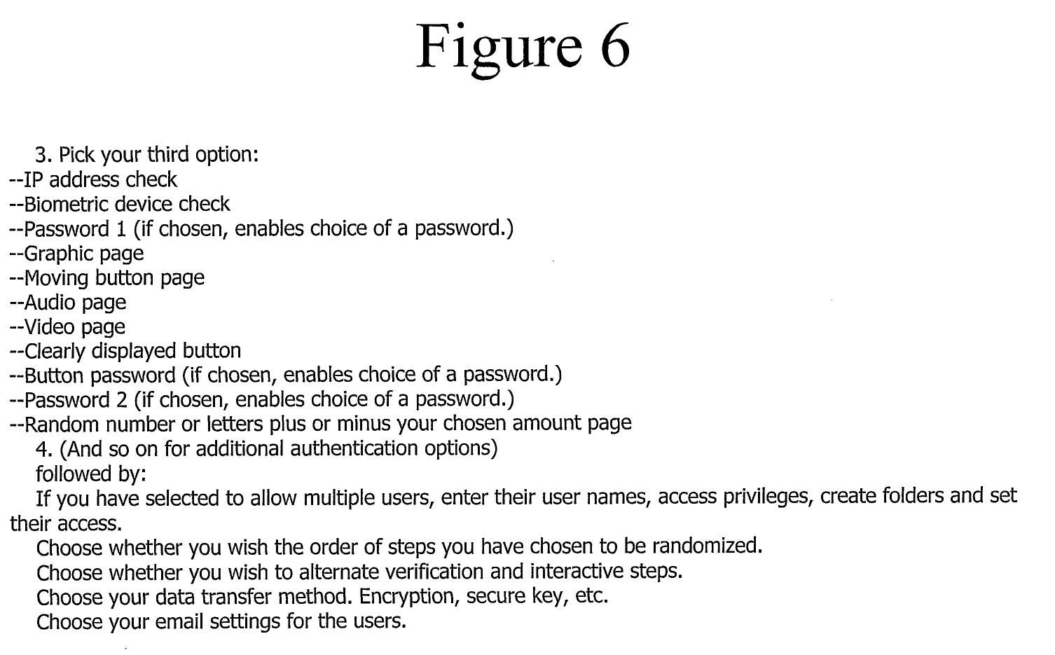

The first step in a security system is the initial sign-up. What is unique to this invention is that this control panel enables a user to configure security options initially and when he returns to the site thereafter. Current art only allows a user to change a user name or password, if at all. Those changes do not affect what is defined as the level of security. (The definition used here excludes changing the number and type of characters in a password as a level of security. This is known in the art as a method of making a password harder to guess, but it does not change the level of security, which involves a qualitative change in the nature of the steps of log-in and their ability to defend against automatic hacking of certain types.) This control panel allows the user to pick settings, types of log-ins, and so on, that affect BOTH the level of security and its specific content. FIGS. 5 and 6 show some possible ways of presenting the options to a user when he comes to sign up. These two figures are not meant to include any choices to the exclusion of others, or to exclude ones not shown or not yet developed, but are rather meant to be illustrative of the invention of allowing users to choose and change their log in procedure and the level of security that they prefer as determined by the strength of the steps that they choose. There are many control panel options such as randomization of questions and of types of questions presented that make it harder for a hacker to use automated programs for breaking into a site.

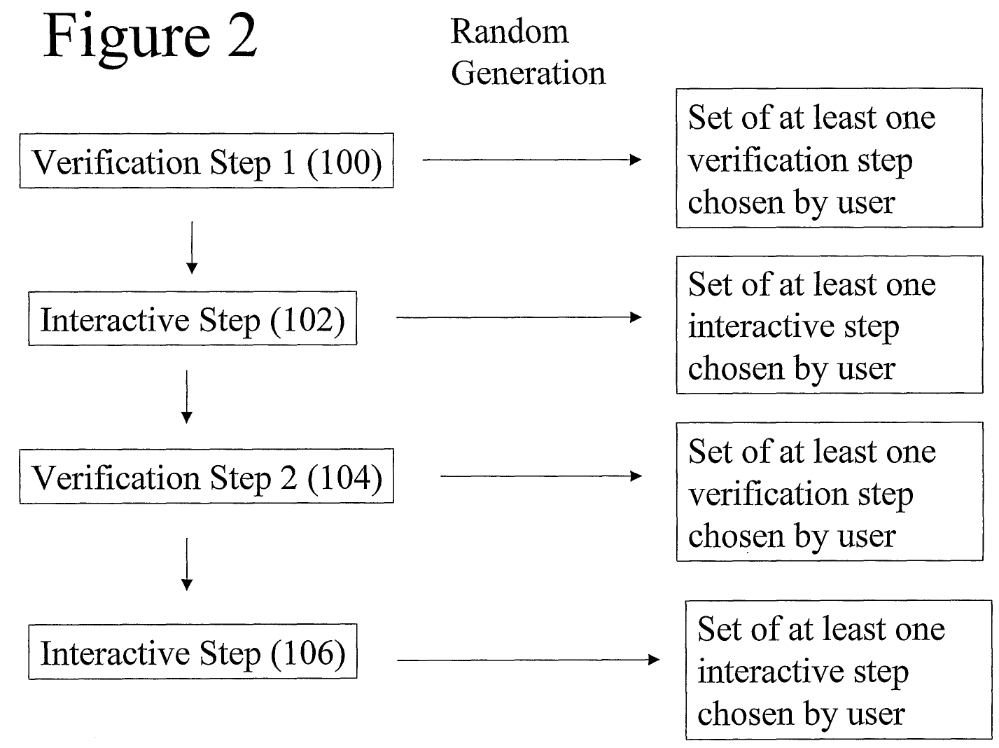

FIG. 2 shows how a user can choose a sequence of the type of log in step, such as interactive or validation step, and can pick randomization of the specific step in that category. For example, a user may choose to always have only two steps in his log in process, but each one of those could change randomly from a set of many log in options. The user chooses the type of step and the specific step he wishes. The ideal sequence is validation (100, 104) followed by interactive (102, 106), so that a step that is hard for a computer to hack separates between one user name/password step and another. The use of randomly generated steps within the categories of validation and interaction, chosen from a group, is preferred, as it makes it difficult for the hacker to predict the sequence, and forces more steps of human interaction outside the hacking program. Those methods, combined with a lockout of any user who fails a specified number of attempts to log in, can discourage a hacker.

A series of options for people with various kinds of disabilities that can work with the above configurations but exclude certain categories of steps, such as those related to sound for those who are deaf, or include ones with sound and exclude those requiring mouse input for those who are blind, may be provided. Options can include using or not using mouse input for any particular step. Options can include making available or unavailable the option of keyboard input for any step.

In the ideal embodiment, said pages have randomly generated steps in the access process. In that manner, it will be harder for a hacker to attack web pages that lead from one randomly generated step to another. (That will be random generation from the group of steps chosen by the user. As a result, the individual will determine his own level of security and those steps that he feels comfortable with.)

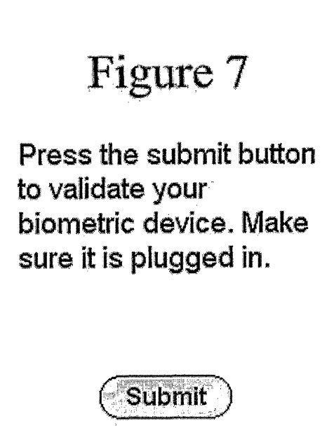

It is now disclosed for the first time a method of providing an option of entry to a secure site, wherein the user is provided with both a verification device and the option of at least one other verification step or interactive step (FIG. 7). The verification device in the ideal configuration is a biometric device that operates not by storing a user name and password, but by storing the biometric input and/or the biometric device serial number, and matching it with information provided on log in.

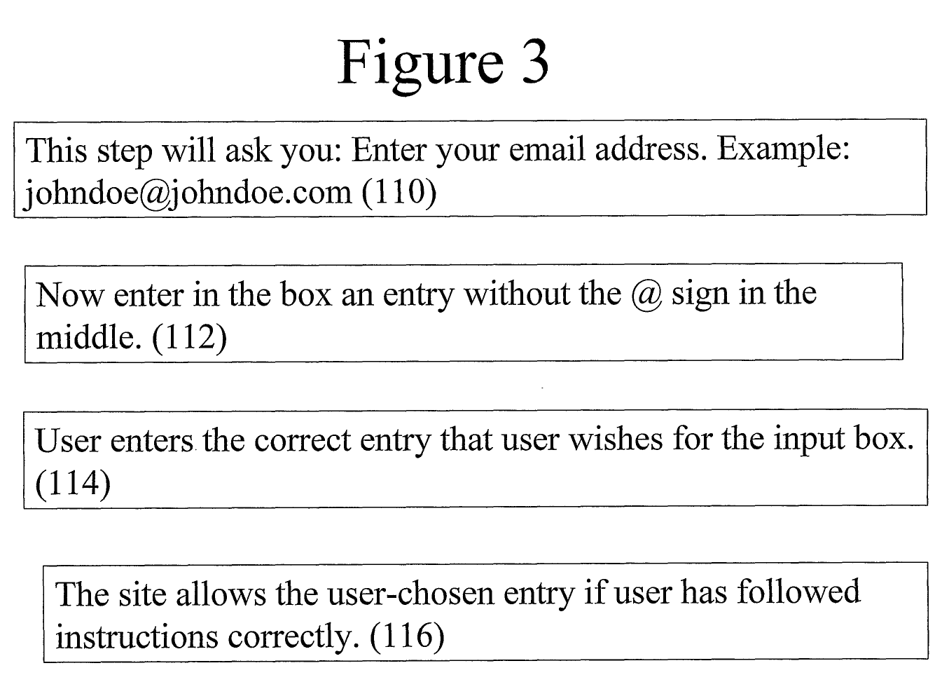

FIG. 3 illustrates the option of a verification step that seemingly requests information (110) different in format from what the user is required to enter—example: asking for the user's email address, but the user knows that he has chosen instead to enter his social security number or some other string of characters (112). The user enters the correct entry (114) while the hacking program is looking for a text string containing the format requested. This misleads the program and the hacker (116).

How does an administrator obtain these options? When the administrator opens the account, he enters his options and may return in the future to change his options (FIGS. 5 and 6). A control panel for picking and managing options for secure access is a novelty of the current invention. When he next logs in, he (or those with subordinate accounts created by the administrator, whose level of rights he will set) will have to proceed through the access steps that were set previously. He will also set access options for those with subordinate accounts. In one embodiment, the user or administrator also sets data storage options. In another embodiment, a master and sub-accounts may be created, with the choice of different passwords, settings, accesses, and devices for the sub-accounts,

Other authentication and verification steps already available may be used as options, such as the well-known CAPTCHAs. In the view of the current invention, the use of distorted or non-distorted pictures, sounds, and so on, is an option because they can be confusing for humans with disabilities as well.

It is now disclosed for the first time a method of providing access to a secure site, wherein the user is provided with the option of picking interactive and verification steps with and without keyboard entry of the button that controls submission. The option may be favored among the disabled who have trouble using a mouse. These methods thereby become perfectly Section 508-compliant in this respect. Section 508 is the rule of the US government regarding the accessibility of government websites for the disabled.

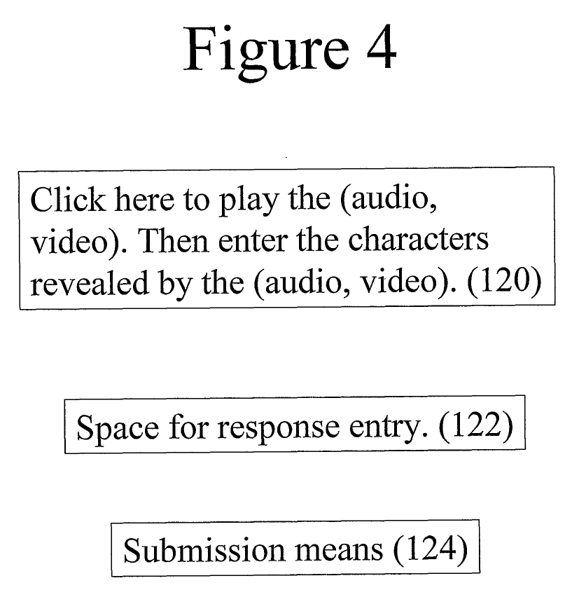

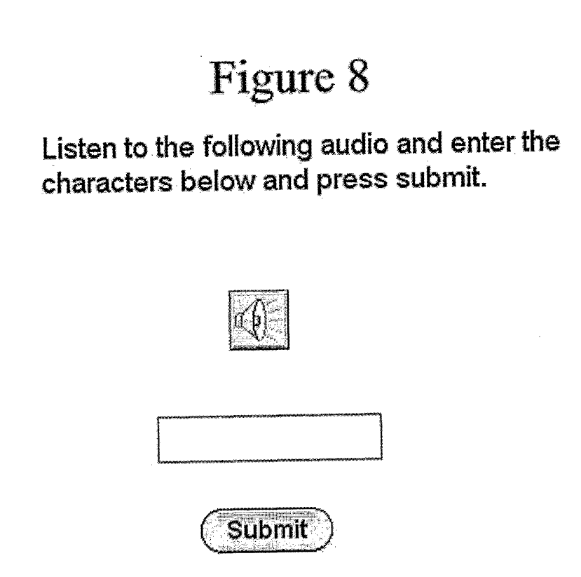

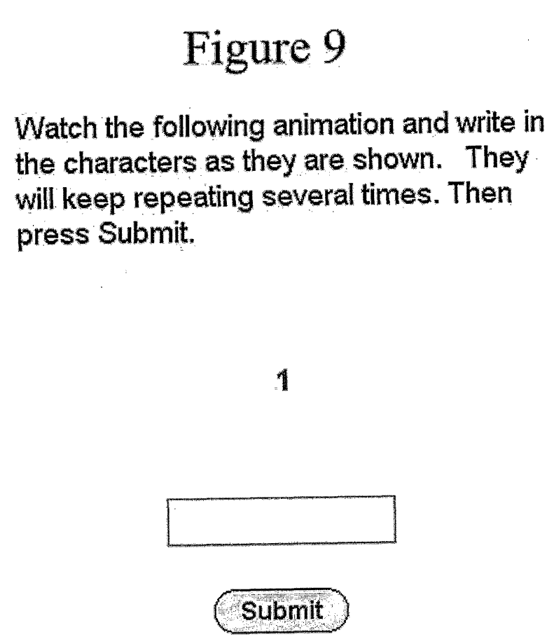

CAPTCHA techniques in current art have not been used with audio and movement/video files. FIG. 4 shows the steps involved for using an audio file as a CAPTCHA. In its simplest form, an audio file needs to be played (120), an entry is required (122), and the site accepts or rejects the entry (124). FIG. 8 shows a picture of how that might appear. FIG. 9 shows the equivalent picture for a file containing movement, which can include animated gif files, movie files, animation files, and so on.

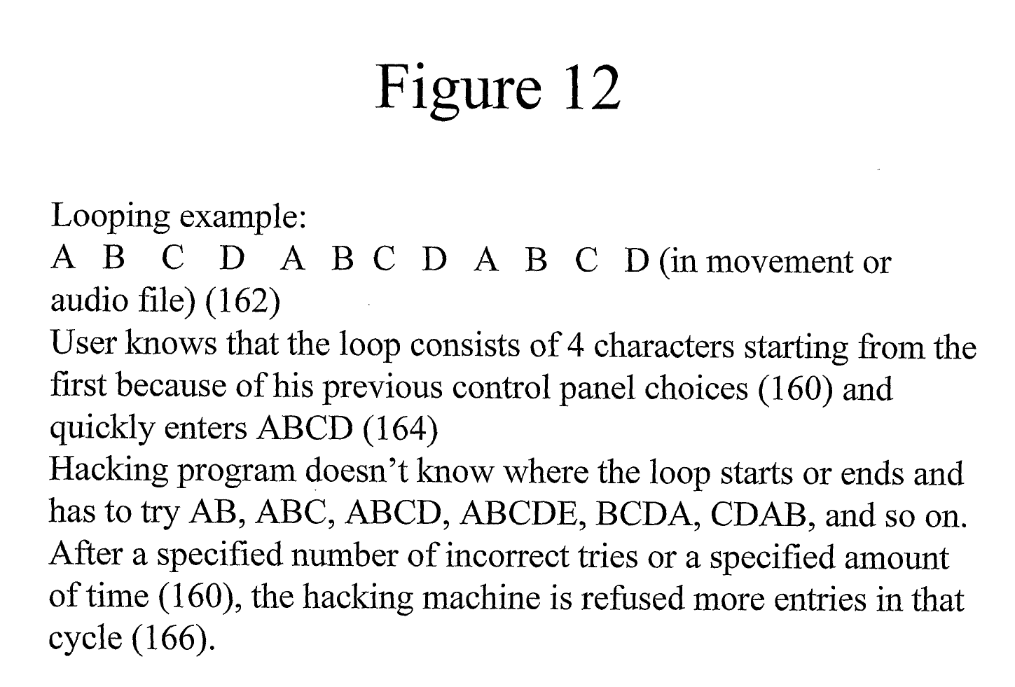

FIG. 12 shows the steps in a more sophisticated variation of an audio or movement file using a string of pieces of information, and, in one embodiment, looping. First the user sets his preferences on his control panel for parameters such as number of tries, when the correct entry should begin—as with the second piece of information, and when the correct entry should end (160). Then when he logs in, he receives a sequence of information, with or without looping (162). He quickly enters the information, because such a user can figure out the correct answer much faster than a hacking computer AND a human. If the user set a time limit for the entry of information for this step on his control panel, he will likely input the required information within that limited time, but a hacking program or another human won't.

A variation on FIG. 12 would be a non-looping string of information, and the user would choose on his control panel a way of identifying when the entry would start—for example, from the first “4” or the first picture containing red—and when the entry would end.

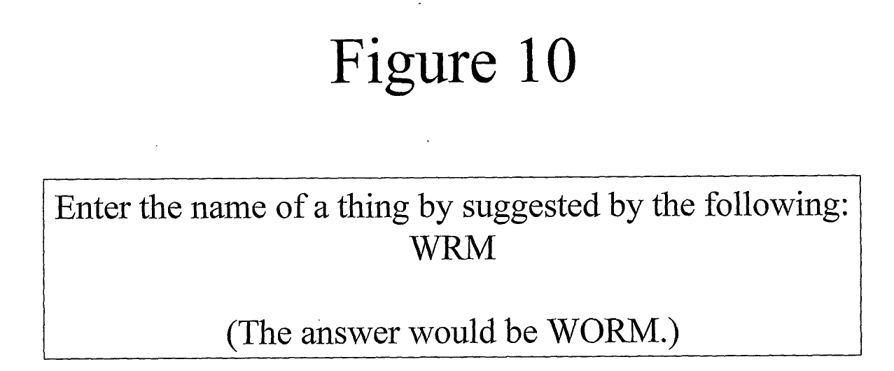

FIG. 10 shows a method of authenticating a user, comprising

a. Providing a page containing information to a user

b. Said information suggests an answer that is not displayed on the screen

c. Requiring input from the user based on said information.

The user may also have chosen the option of automatic IP verification without recourse to a special step that appears on login.

The step of FIG. 7 can also apply to verification of a chip embedded into or attached to a cell phone or other memory-based device.

FIG. 7 illustrates the option of validating a biometric device. A Submit button allows entry of the choice. An entry of data not matching the memory of the security system's database, or not matching set criteria, will reject the entry. In an additional embodiment, the same process can be enabled for other personal devices that are not biometric, such as a card key or USB key with an embedded code.

Another choice of verification step would be using the processor serial number on the user's computer. The user would be given instructions on how to make sure the processor serial number was unlocked.

It is now disclosed for the first time a method of network security, comprising

a. creating a sound file reading distorted or non-distorted information by random generation on a web page,
b. providing a form for and requiring entry of the same randomly generated characters or information into a form on the web page,
c. providing a means for the submission of said form

FIG. 8 is an example of the process just described. A Submit button allows entry of the choice. An entry not written into the memory of the security system's database will reject the access.

The advantage of this and other similar methods described in this patent of requiring input from information made available to the person logging in is the prevention of automated hacking.

It is now disclosed for the first time a method of network security, comprising

a. creating a distorted or non-distorted movie or animation or animated GIF file revealing an instruction such as reading or displaying characters by random generation on a web page,
b. providing a form for and requiring entry of the same randomly generated characters or instruction into a form on the web page,
c. providing a means for the submission of said form

FIG. 9 is an example of the process just described. A Submit button allows entry of the choice. An incorrect entry will be rejected.

FIG. 12 shows how audio or movement files can be used in a loop, and that loop can confuse a hacking program or human.

The user uses his control panel to change his options as desired. For example, if he will be traveling and chooses not to use a biometric device or IP address verification, he can log in to his control panel and change the options before he leaves.

In another embodiment, the owner of the account has the option of setting access for only one IP (Internet Protocol) address for any user on said account at any time. Many users have a fixed IP address and this can be monitored. Or a company has a single fixed IP that the administrator can select to make a condition of entry for the entire company. This means that a hacker or intruder cannot login as that user from a different computer. Monitoring of dynamic IP addresses of those who do not make successful entry to the site is part of the current methods.

The above security options can be used, in whole or in part, for many applications, such as web-based email, shopping carts, and online storage. The above security options can be available to the customer as an outsourced, “asp” (application service provider) type of solution, or as a program that the web site offering the security controls installs and pays for on a regular basis, or as a program for the user to keep and use for interactions with various sites.

It is now disclosed for the first time a web-based storage method, comprising

a) Providing web-based email,
b) Providing web-based storage folders wherein web-based email messages and other files may be stored in the same folder.
The ability to store these files together is a significant advance in customer convenience. All current web-based email has storage only for its own email, not for other files in the same directory.

In another embodiment, said folders are in the client's rented online storage space. In another embodiment, a storage option on the user menu that saves email messages to said storage space is provided. Space reserved for the user on the server therefore accommodates the use of folders to place email files and other files in one convenient server space.

It is now disclosed for the first time an email method, comprising the option of saving of email messages as at least one of the group consisting of editable text files, unalterable text files, Unicode files, and email files. In another embodiment, saving of said files is onto a storage space designated by the user. The rationale is that some users may want the email in a particular text format, such as .txt or .doc, rather than in an email only file, such as .eml. The purpose of the unalterable text file is for documentation of correspondence.

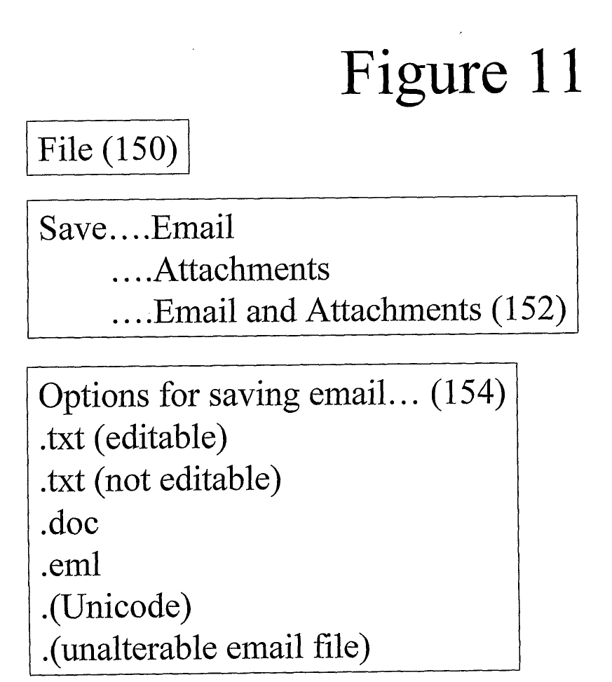

FIG. 11 illustrates how a “File” or other menu or button command (150), in the ideal embodiment, could open up another set of choices for how and where to save email and attachments (152, 154).

It is now disclosed for the first time an email method, comprising the option of signing up for an ultrasecure email online web access, using the methods previously described. In addition, the user may sign up in the sign-up process for integration of email folders with other web-based folders. The advantage to the users is that they can put all files they need to back up into one convenient site.

It is now disclosed for the first time a method of managing a customer shopping cart or customer online account, comprising a set of choices for users to manage the parameters of logging in, as per the present invention.

All methods described in the current invention also refer to the physical devices running the methods described by writing the displays, commands, and inputs into memory and to the providing of devices that accomplish the methods herein described. Computerized entries, pages, and interactions are recorded or produced using the discs, chips, or memory containing database and other programs. All pages used for network access are produced using computerized devices that present the inventions described to the user and/or store data involved in the methods described herein. The user also requires his own hardware to interact with the network access pages. Files and file names are written to a physical memory device such as a hard drive.

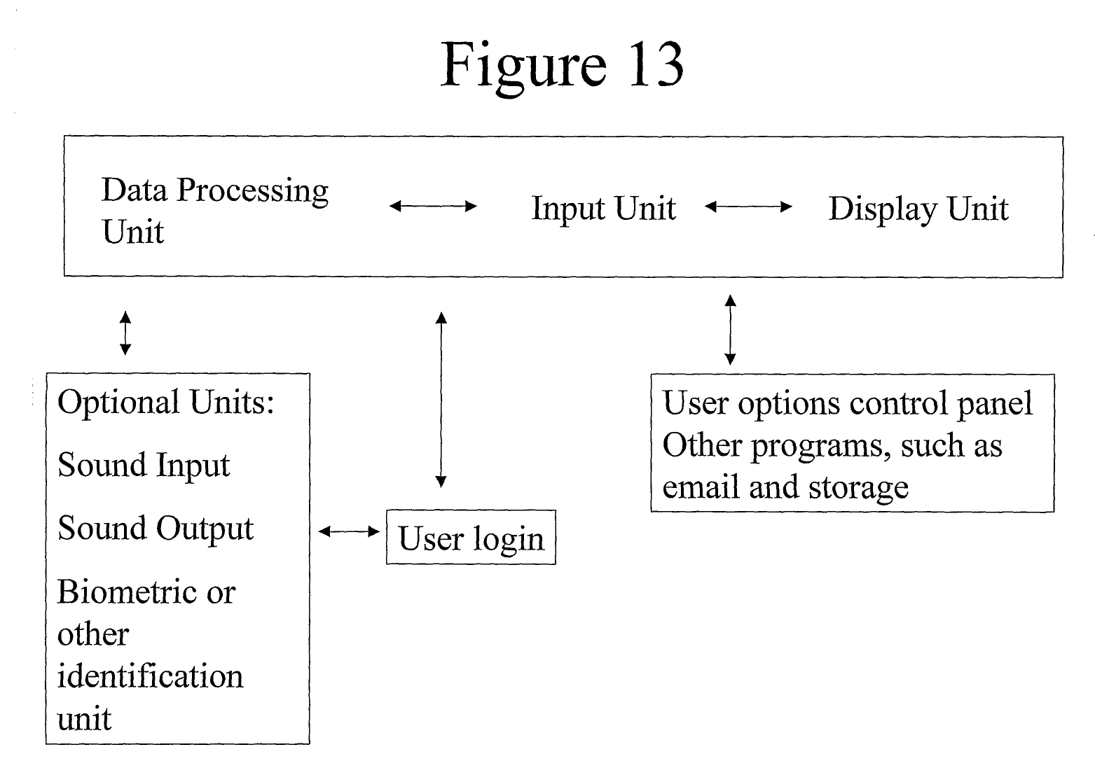

FIG. 13 is a diagram of the devices involved in the apparatuses described and their relationships to each other and the user. The basic devices required are a data processing unit, an input unit, and a display unit. The data processing unit—which can consist of more than one unit and be a network as well—holds the memory and the application which run the user interface and enable the software to manage the user control panel and the user log-in. Other optional devices, not to the exclusion of any others, attached to the main group of three devices are a sound input device, a sound output device, and a biometric or other identification key device such as a card token.

All the above inventions apply to devices containing memory, such as computers, cell phones, cell phone information chips, personal data assistants, web TVs, etc.

While the invention has been described with respect to a limited number of embodiments, it will be appreciated that many variations, modifications and other applications of the invention may be made.

### SUMMARY

It is now disclosed for the first time a method of allowing access to a secure site, comprising:

a. a first verification step,
b. a second step, the type of which is either an interactive step or a verification step, said step randomly generated from a set of at least one choice of the two said types of steps

According to some embodiments, the method further comprises:

c. at least a third step, the type of which is either interactive or verification, each said step randomly generated from a set of at least one choice of the two said types of steps.

According to some embodiments, the method further comprises the following condition: if step b is not an interactive step, step c is an interactive step.

According to some embodiments, the method further comprise a biometric reading consisting of identification of the characteristic read by the device as a verification step.

According to some embodiments, the method further comprises every odd-numbered step being a verification step, and every even-numbered step being an interactive step.

According to some embodiments, the method further comprises the method wherein one of the verification steps is a non-biometric device attached to the user's input device.

According to some embodiments, the method further comprises the method wherein the interactive or verification type of the second step onwards is randomly generated.

According to some embodiments, the method further comprises the method wherein log in is denied if the user signing in misses a defined number of attempts decided by the user on his control panel at any step.

It is now disclosed for the first time a method of constructing a verification step for access to a secure site, comprising:

a. the user choosing a verification step to be used on the user's next log-in
b. the site showing the user the format of the question presented in the verification step and suggesting the choice of a different format or content of actual entry, said verification step consisting of the presentation of a specific format and the offer of a choice of a different format for actual entry.
c. the user indicating a choice of the presentation characteristics and actual entry format
d. the site saves the user's choice
e. the site refuses or permits user access based on correct entry of the step on the next log in.

It is now disclosed for the first time a method of presenting a step allowing access to a secure site, comprising

a. Providing a sound output to a user
b. Requiring input from the user based on said sound output
c. Providing a means for the submission of said input and matching it to the correct answer.
d. Rejecting or permitting the user to proceed

According to some embodiments, the method further comprises the method wherein the sounds are distorted.

According to some embodiments, the method further comprises the method wherein the sounds are randomly generated.

It is now disclosed for the first time a method of presenting a step allowing access to a secure site, comprising

a. Providing an output containing movement to a user
b. Requiring input from the user based on said movement output
c. Providing a means for the submission of said input and matching it to the correct answer to enable or refuse entry.
d. Rejecting or permitting the user to proceed to the secure site

According to some embodiments, the method further comprises the method wherein the information in the frames shown is distorted.

According to some embodiments, the method further comprises the method wherein the information in the frames shown is randomly generated.

It is now disclosed for the first time a method of presenting a step allowing access to a secure site, comprising

a. Providing a page containing information that requests an input from a user
b. The correct input is dissimilar from the input apparently requested on the page, but has been previously picked by the user on his control panel
c. Requiring input from the user based on said information
d. Rejecting or permitting the user to proceed to the secure site

It is now disclosed for the first time a method of presenting a step allowing access to a secure site, comprising

a. the user selects on his control panel at least one option for the sequential presentation of a string of pieces of information, said options drawn at least from the group of starting entry point, ending entry point, the number of characters to be entered, the pattern of the characters to be entered, limit of time to enter the input, the timing of the intervals between one piece of presented information and the next, the time allowed for entry of the response after the last required piece of information is presented, the time allowed for entry of the response after the first significant piece of information is presented, string looping, randomization of pieces of information, inclusion of a pattern of nonsense information, visual format of presentation, audio format of presentation, sensory format of presentation, and other parameters of input,
b. the presentation of information is presented to the user on log in
c. the user enters a response
d. the site permits or refuses entry based on the response.

According to some embodiments, the method further comprises:

the timing of the intervals between loops is previously chosen or randomized by the user on his control panel,

It is now disclosed for the first time a method of allowing access to a secure site, comprising:

a. Providing a control panel with choices to the user that enables alteration of the level of security
b. Recording said client's choices
c. Providing choices per previous client instruction when client logs into said account

According to some embodiments, the method further comprises the method wherein other security parameters may be set

According to some embodiments, the method further comprises: a choice of at least one verification and one interactive step

According to some embodiments, the method further comprises: a choice of the number of steps,

According to some embodiments, the method further comprises: a choice of the randomization of the steps

According to some embodiments, the method further comprises: a choice of the order of the steps

According to some embodiments, the method further comprises: a choice of the content of each step

According to some embodiments, the method further comprises: a choice of a biometric device

According to some embodiments, the method further comprises: a choice of an alternate entry method to be made available to the user if the biometric device is not available

According to some embodiments, the method further comprises: a choice of breaking up a set of validation steps with at least one interactive step

According to some embodiments, the method further comprises: a choice of input prompts for any step.

According to some embodiments, the method further comprises: the option of permitting only keyboard use for information entry in any step.

According to some embodiments, the method further comprises: the option of permitting only mouse use for information entry in any step.

According to some embodiments, the method further comprises: the option of setting the correct input for a step to be different from the displayed value by a fixed formula chosen by the client.

According to some embodiments, the method further comprises: the option for the user to reconfigure his sign-in options at any time.

According to some embodiments, the method further comprises: an option for an administrator to set options for sub-accounts.

According to some embodiments, the method further comprises:

providing a set of choices for the user to manage the parameters of data storage

According to some embodiments, the method further comprises:

providing a set of choices for the user to manage the parameters of data transfer protection methods.

According to some embodiments, the method further comprises the method wherein the access is to a web-based email program.

According to some embodiments, the method further comprises the method wherein the access is to a file storage program.

According to some embodiments, the method further comprises the method wherein the access is to a shopping cart program.

According to some embodiments, the method further comprises the method wherein the access is to a web-based email program and a file storage program.

According to some embodiments, the method further comprises: a web-based email program that saves mail to the folders on a user's web-based storage space.

According to some embodiments, the method further comprises the method wherein the access is to a personal device email program.

It is now disclosed for the first time a method of allowing access to a secure site, comprising:

a. Providing a control panel to allow the user to set access options
b. Providing a choice for a biometric device to be provided
c. User sets access options temporarily without the biometric device
According to some embodiments, the method further comprises:
d. said user logs in to his options panel and elects to add a biometric device to user log in choices
e. said biometric device having a computer-readable serial number
f. said site enters the serial number in memory
g. said site compares on log in the serial number in memory and the serial number of the biometric device.
According to some embodiments, the method further comprises:
d. said user logs in to his options panel and elects to add a biometric device to user log in choices
e. said biometric device reads a characteristic of the user
f. said characteristic is stored in the site memory
g. said site compares on log in the characteristic stored in memory with the characteristic read on the device.

It is now disclosed for the first time a method of providing services on a secure site, comprising

a. the combination of web-based email and file storage on one site saving data to the same directory

According to some embodiments, the method further comprises:

b. the user setting up folders in said directory from either the file storage application or the email application

It is now disclosed for the first time a method of saving email messages, comprising the menu option of saving of email messages as at least one format drawn from the group of editable text files, unalterable text files, files of a particular program, Unicode files, and email files.

It is now disclosed for the first time a method of saving email messages, comprising the menu option of saving of email messages and attachments simultaneously to the same folder.

It is now disclosed for the first time an apparatus for allowing access to a secure site, the apparatus comprising:

a. at least one data processing unit having computer-executable instructions
b. an input device connected to said data processing unit
c. a display unit functionally connected to said data processing unit and operative to display a first verification step, and a second step, the type of which is either an interactive step or a verification step, said step randomly generated from a set of at least one choice of the two said types of steps.

According to some embodiments, the apparatus further comprises the apparatus wherein the display unit further is operative to display at least a third step, the type of which is either interactive or verification, each said step randomly generated from a set of at least one choice of the two said types of steps.

According to some embodiments, the apparatus further comprises the apparatus wherein the data processing unit has executable instructions to perform the following: if step b is not an interactive step, step c is an interactive step.

According to some embodiments, the apparatus further comprises:

a biometric device read by the data processing unit, which is operative to compare a characteristic read by the device with the memory in the data processing unit, as a verification step.

According to some embodiments, the apparatus further comprises the apparatus wherein said data processing unit has executable instructions to make every odd-numbered step a verification step, and every even-numbered step an interactive step.

According to some embodiments, the apparatus further comprises:

a non-biometric device attached to the user's input device, said non-biometric device operative to perform a verification step.

According to some embodiments, the apparatus further comprises the apparatus wherein the data processing unit randomly generates an interactive or verification type of the second step onwards.

According to some embodiments, the apparatus further comprises the apparatus wherein the data processing unit denies log in if the information from the input device fails to match with the information in the memory of the data processing unit after a defined number of attempts written to the memory of the data processing unit.

It is now disclosed for the first time an apparatus operative to construct a verification step for access to a secure site, comprising:

a. a data processing unit
b. an input unit connected to the data processing unit
c. a display unit connected to the data processing unit, said display unit operative to show on the screen a format of a question from a verification step, said display suggesting the choice of a format or content of input entry that does not match the format or content of the correct input entry to be held in memory.
d. said display unit is operative to display a choice of the presentation characteristics of the question and actual entry format
e. said data processing unit is operative to save the user's choice in its memory
f. the data processing unit is operative to refuse or permit user access based on matching input unit information to the correct entry of the step held in memory on the next log in.

It is now disclosed for the first time an apparatus for presenting a step allowing access to a secure site, comprising

a. a data processing unit connected to at least one key input unit, sound output unit, display unit, and sound input unit
b. said data processing unit provides a sound output
c. said display unit is operative to provide a place for the user to key in a response based on said sound output
d. Said data processing unit compares said input to the correct answer in the unit's memory to reject or permit logon.

According to some embodiments, the apparatus further comprises the apparatus wherein the data processing unit is operative to distort the sound outputs.

According to some embodiments, the apparatus further comprises the apparatus wherein the data processing unit randomly generates the sounds.

It is now disclosed for the first time an apparatus for presenting a step allowing access to a secure site, comprising

a. a data processing unit connected to at least one key input unit and a display unit
b. said data processing unit is operative to provide a moving visual output on the display unit
c. said display unit provides a place for the user to key in a response based on said output
d. said data processing unit compares said input to the correct answer in the data processing unit's memory to reject or permit logon.

According to some embodiments, the apparatus further comprises the apparatus wherein the data processing unit is operative to distort the moving visual outputs on the display unit.

According to some embodiments, the apparatus further comprises the apparatus wherein the data processing unit randomly generates the moving visual outputs on the display unit.

It is now disclosed for the first time an apparatus for presenting a step allowing access to a secure site, comprising

a. a data processing unit
b. a display unit connected to said data processing unit and displaying a page containing information that requests an input from a user
c. said data processing unit has stored the correct input in its memory, based on previous input by the user, and instructs the display unit to display a request for input of information on the screen, said input apparently requested being dissimilar from the correct input stored in the memory.
d. said display unit is operative to request input from the user based on said information
e. said data processing unit compares said input to the correct answer in the unit's memory to reject or permit logon.

It is now disclosed for the first time an apparatus for presenting a step allowing access to a secure site, comprising

a. a data processing unit, connected to a display unit and an input unit
b. the three said units are operative to perform the following executable action: the user on said units selects on his control panel generated by the data processing unit and displayed on the display unit at least one option for the sequential presentation of a string of pieces of information, said options drawn at least from the group of starting entry point, ending entry point, the number of characters to be entered, the pattern of the characters to be entered, limit of time to enter the input, the timing of the intervals between one piece of presented information and the next, the time allowed for entry of the response after the last required piece of information is presented, the time allowed for entry of the response after the first significant piece of information is presented, string looping, randomization of pieces of information, inclusion of a pattern of nonsense information, visual format of presentation, audio format of presentation, sensory format of presentation, and other parameters of input,
b. the display unit shows information to the user on subsequent log in
c. the entry unit delivers a response from the user to the data processing unit
d. said data processing unit compares said input to the correct answer in the unit's memory to reject or permit logon.

According to some embodiments, the apparatus further comprises:

the data processing unit is operative to perform the timing of the intervals between loops according to previous choices by the user written into the data processing unit's memory.

It is now disclosed for the first time an apparatus for allowing access to a secure site, comprising:

a. a data processing unit connected to a display unit and an input unit
b. said display unit displays a control panel with choices to the user that enable alteration of the level of security
c. a memory on the data processing unit to which user choices are written
d. said display unit is operative to provide choices per previous user instruction when client logs into said account.

According to some embodiments, the apparatus further comprises the apparatus wherein the data processing unit is operative to set other security parameters according to instructions entered from the input unit.

According to some embodiments, the apparatus further comprises the apparatus wherein said display unit is operative to display a choice of at least one verification and one interactive step

According to some embodiments, the apparatus further comprises the apparatus wherein said display unit is operative to display a choice of the number of steps,

According to some embodiments, the apparatus further comprises the apparatus wherein said display unit is operative to display a choice of the randomization of the steps.

According to some embodiments, the apparatus further comprises the apparatus wherein said display unit is operative to display a choice of the order of the steps.

According to some embodiments, the apparatus further comprises the apparatus wherein said display unit is operative to display a choice of the content of each step.

According to some embodiments, the apparatus further comprises the apparatus wherein said display unit is operative to display a choice of a biometric device.

According to some embodiments, the apparatus further comprises the apparatus wherein said display unit is operative to display a choice of an alternate entry apparatus to be made available to the user if the biometric device is not available.

According to some embodiments, the apparatus further comprises the apparatus wherein said display unit is operative to display a choice of breaking up a set of validation steps with at least one interactive step.

According to some embodiments, the apparatus further comprises the apparatus wherein said display unit is operative to display a choice of input prompts for any step.

According to some embodiments, the apparatus further comprises the apparatus wherein said display unit is operative to display the option of permitting only keyboard use for information entry in any step.

According to some embodiments, the apparatus further comprises the apparatus wherein said display unit is operative to display the option of permitting only mouse use for information entry in any step.

According to some embodiments, the apparatus further comprises the apparatus wherein said display unit is operative to display the option of setting the correct input for a step to be different from the displayed value by a fixed formula chosen by the client.

According to some embodiments, the apparatus further comprises the apparatus wherein said display unit is operative to display the option for the user to reconfigure his sign-in options at any time.

According to some embodiments, the apparatus further comprises the apparatus wherein said display unit is operative to display an option for an administrator to set options for sub-accounts.

According to some embodiments, the apparatus further comprises the apparatus wherein said display unit is operative to display a set of choices for the user to manage the parameters of data storage.

According to some embodiments, the apparatus further comprises the apparatus wherein said display unit is operative to display a set of choices for the user to manage the parameters of data transfer protection apparatus.

According to some embodiments, the apparatus further comprises the apparatus wherein said display unit is operative to display a choice for access is to a web-based email program.

According to some embodiments, the apparatus further comprises the apparatus wherein said display unit is operative to display a choice for access to a file storage program.

According to some embodiments, the apparatus further comprises the apparatus wherein said display unit is operative to display a choice for access to a shopping cart program.

According to some embodiments, the apparatus further comprises the apparatus wherein said display unit is operative to display a choice for access to a web-based email program and a file storage program.

According to some embodiments, the apparatus further comprises the apparatus wherein said display unit is operative to display a choice for a web-based email program that saves mail to folders on a user's web-based storage space.

According to some embodiments, the apparatus further comprises the apparatus wherein said display unit is operative to display a choice for access to a personal device email program.

It is now disclosed for the first time an apparatus allowing access to a secure site, comprising:

a. a data-processing unit, connected to a display unit and an input unit
b. said display unit is operative to display a control panel to allow the user to set access options
c. Computer executable instructions on the data processing unit, operative provide a choice for a biometric device to communicate with the data processing unit
d. Computer executable instructions operative to enable the user to set access options temporarily without the biometric device.

According to some embodiments, the apparatus further comprises:

e. said data processing unit is operative to allow the user to log in to his options control panel and elect to add a biometric device to user log in choices
f. a biometric device having a computer-readable serial number
g. said data processing unit is operative to enter the serial number in memory
h. said data processing unit is operative to compare on subsequent log in the serial number in memory and the serial number of the biometric device.

According to some embodiments, the apparatus further comprises:

e. said data processing unit is operative to allow said user to log in to his options panel and elect to add a biometric device to user log in choices
f. said biometric device is operative to read a characteristic of the user
g. said data processing unit is operative to store the characteristic in memory
h. said data processing unit is operative to compare on subsequent log in the characteristic stored in memory with the characteristic read on the device.

It is now disclosed for the first time an apparatus for providing services on a secure site, comprising

a. a data processing unit, a display unit, and an input unit
b. said data processing unit is operative to produce a site where the data of web-based email and file storage are saved in memory to the same virtual directory

According to some embodiments, the apparatus further comprises:

c. said data processing unit is operative to enable the user to set up folders in said virtual directory from either the file storage application or the email application.

It is now disclosed for the first time an apparatus of saving email messages, comprising

a. a data processing unit, a display unit, and an input unit
b. computer executable instructions on the data processing unit, said instructions displaying on the display unit the menu option of saving of email messages as at least one format drawn from the group of editable text files, unalterable text files, files of a particular program, Unicode files, and email files.

It is now disclosed for the first time an apparatus of saving email messages, comprising:

a. a data processing unit, a display unit, and an input unit
b. computer executable instructions on the data processing unit, said instructions displaying on the display unit the menu option of saving of email messages and attachments simultaneously to the same folder on the data processing unit.

What is claimed is:

1. A method of allowing access to a secure site, comprising
a. a first verification step,
b. a second step, the type of which is either an interactive step or a verification step, said step randomly generated from a set of at least one choice of the two said types of steps.

2. The method of claim 1, further comprising
c. at least a third step, the type of which is either interactive or verification, each said step randomly generated from a set of at least one choice of the two said types of steps.

3. The method of claim 2, wherein: if step b is not an interactive step, step c is an interactive step.

4. The method of claim 1, wherein a biometric reading consisting of identification of the characteristic read by the device is a verification step.

5. The method of claim 1, wherein every odd-numbered step is a verification step, and every even-numbered step is an interactive step.

6. The method of claim 1, wherein one of the verification steps is a non-biometric device attached to the user's input device.

7. The method of claim 1, wherein the interactive or verification type of the second step onwards is randomly generated.

8. The method of claim 1, wherein log in is denied if the user signing in misses a defined number of attempts decided by the user on his control panel at any step.

9. A method of constructing a verification step for access to a secure site, comprising:
a. the user choosing a verification step to be used on the user's next log-in
b. the site showing the user the format of the question presented in the verification step and suggesting the choice of a different format or content of actual entry, said verification step consisting of the presentation of a specific format and the offer of a choice of a different format for actual entry.
c. the user indicating a choice of the presentation characteristics and actual entry format
d. the site saves the user's choice
e. the site refuses or permits user access based on correct entry of the step on the next log in.

10. A method of presenting a step allowing access to a secure site, comprising
a. providing a sound output to a user
b. requiring input from the user based on said sound output
c. providing a means for the submission of said input and matching it to the correct answer.
d. Rejecting or permitting the user to proceed

11. The method of claim 10, wherein the sounds are distorted.

12. The method of claim 10, wherein the sounds are randomly generated.

13. A method of presenting a step allowing access to a secure site, comprising
a. providing an output containing movement to a user
b. requiring input from the user based on said movement output
c. providing a means for the submission of said input and matching it to the correct answer to enable or refuse entry.
d. rejecting or permitting the user to proceed to the secure site

14. The method of claim 13, wherein the information in the frames shown is distorted.

15. The method of claim 13, wherein the information in the frames shown is randomly generated.

16. A method of presenting a step allowing access to a secure site, comprising
a. providing a page containing information that requests an input from a user
b. the correct input is dissimilar from the input apparently requested on the page, but has been previously picked by the user on his control panel
c. requiring input from the user based on said information
d. rejecting or permitting the user to proceed to the secure site

17. A method of presenting a step allowing access to a secure site, comprising
a. the user selects on his control panel at least one option for the sequential presentation of a string of pieces of information, said options drawn at least from the group of starting entry point, ending entry point, the number of characters to be entered, the pattern of the characters to be entered, limit of time to enter the input, the timing of the intervals between one piece of presented information and the next, the time allowed for entry of the response after the last required piece of information is presented, the time allowed for entry of the response after the first significant piece of information is presented, string looping, randomization of pieces of information, inclusion of a pattern of nonsense information, visual format of presentation, audio format of presentation, sensory format of presentation, and other parameters of input,
b. the presentation of information is presented to the user on log in
c. the user enters a response
d. the site permits or refuses entry based on the response.

18. The method of claim 17, further comprising:
the timing of the intervals between loops is previously chosen or randomized by the user on his control panel.

19. A method of allowing access to a secure site, comprising:
a. providing a control panel with choices to the user that enables alteration of the level of security
b. recording said client's choices
c. providing choices per previous client instruction when client logs into said account.

20. The method of claim 19, wherein other security parameters may be set

21. The method of claim 19, further comprising a choice of at least one verification and one interactive step

22. The method of claim 19, further comprising a choice of the number of steps,

23. The method of claim 19, further comprising a choice of the randomization of the steps

24. The method of claim 19, further comprising a choice of the order of the steps

25. The method of claim 19, further comprising a choice of the content of each step

26. The method of claim 19, further comprising a choice of a biometric device

27. The method of claim 26, further comprising a choice of an alternate entry method to be made available to the user if the biometric device is not available

28. The method of claim 19, further comprising a choice of breaking up a set of validation steps with at least one interactive step

29. The method of claim 19, further comprising a choice of input prompts for any step.

30. The method of claim 19, further comprising the option of permitting only keyboard use for information entry in any step.

31. The method of claim 19, further comprising the option of permitting only mouse use for information entry in any step.

32. The method of claim 19, further comprising the option of setting the correct input for a step to be different from the displayed value by a fixed formula chosen by the client.

33. The method of claim 19, further comprising the option for the user to reconfigure his sign-in options at any time.

34. The method of claim 19, further comprising an option for an administrator to set options for sub-accounts.

35. The method of claim 19, further comprising:
providing a set of choices for the user to manage the parameters of data storage

36. The method of claim 19, further comprising:
providing a set of choices for the user to manage the parameters of data transfer protection methods.

37. The method of claim 19, wherein the access is to a web-based email program.

38. The method of claim 19, wherein the access is to a file storage program.

39. The method of claim 19, wherein the access is to a shopping cart program.

40. The method of claim 19, wherein the access is to a web-based email program and a file storage program.

41. The method of claim 40, further comprising a web-based email program that saves mail to the folders on a user's web-based storage space.

42. The method of claim 19, wherein the access is to a personal device email program.

43. A method of allowing access to a secure site, comprising:
a. providing a control panel to allow the user to set access options
b. providing a choice for a biometric device to be provided
c. user sets access options temporarily without the biometric device

44. The method of claim 43, further comprising:
d. said user logs in to his options panel and elects to add a biometric device to user log in choices
e. said biometric device having a computer-readable serial number
f. said site enters the serial number in memory
g. said site compares on log in the serial number in memory and the serial number of the biometric device.

45. The method of claim 43, further comprising:
d. said user logs in to his options panel and elects to add a biometric device to user log in choices
e. said biometric device reads a characteristic of the user
f. said characteristic is stored in the site memory
g. said site compares on log in the characteristic stored in memory with the characteristic read on the device.

46. The method of providing services on a secure site, comprising
a. the combination of web-based email and file storage on one site saving data to the same directory

47. The method of claim 46, further comprising
b. the user setting up folders in said directory from either the file storage application or the email application

48. The method of saving email messages, comprising the menu option of saving of email messages as at least one format drawn from the group of editable text files, unalterable text files, files of a particular program, Unicode files, and email files.

49. The method of saving email messages, comprising the menu option of saving of email messages and attachments simultaneously to the same folder.

50. An apparatus for allowing access to a secure site, the apparatus comprising:
a. at least one data processing unit having computer-executable instructions
b. an input device connected to said data processing unit
c. a display unit functionally connected to said data processing unit and operative to display a first verification step, and a second step, the type of which is either an interactive step or a verification step, said step randomly generated from a set of at least one choice of the two said types of steps.

51. The apparatus of claim 50, wherein the display unit further is operative to display at least a third step, the type of which is either interactive or verification, each said step randomly generated from a set of at least one choice of the two said types of steps.

52. The apparatus of claim 50, wherein the data processing unit has executable instructions to perform the following: if step b is not an interactive step, step c is an interactive step.

53. The apparatus of claim 50, further comprising:
a biometric device read by the data processing unit, which is operative to compare a characteristic read by the device with the memory in the data processing unit, as a verification step.

54. The apparatus of claim 50, wherein said data processing unit has executable instructions to make every odd-numbered step a verification step, and every even-numbered step an interactive step.

55. The apparatus of claim 50, further comprising:
a non-biometric device attached to the user's input device, said non-biometric device operative to perform a verification step.

56. The apparatus of claim 50, wherein the data processing unit randomly generates an interactive or verification type of the second step onwards.

57. The apparatus of claim 50, wherein the data processing unit denies log in if the information from the input device fails to match with the information in the memory of the data processing unit after a defined number of attempts written to the memory of the data processing unit.

58. A apparatus operative to construct a verification step for access to a secure site, comprising:
a. a data processing unit
b. an input unit connected to the data processing unit
c. a display unit connected to the data processing unit, said display unit operative to show on the screen a format of a question from a verification step, said display suggesting the choice of a format or content of input entry that does not match the format or content of the correct input entry to be held in memory.
d. said display unit is operative to display a choice of the presentation characteristics of the question and actual entry format
e. said data processing unit is operative to save the user's choice in its memory
f. the data processing unit is operative to refuse or permit user access based on matching input unit information to the correct entry of the step held in memory on the next log in.

59. An apparatus for presenting a step allowing access to a secure site, comprising
a. a data processing unit connected to at least one key input unit, sound output unit, display unit, and sound input unit
b. said data processing unit provides a sound output
c. said display unit is operative to provide a place for the user to key in a response based on said sound output
d. said data processing unit compares said input to the correct answer in the unit's memory to reject or permit logon.

60. The apparatus of claim 59, wherein the data processing unit is operative to distort the sound outputs.

61. The apparatus of claim 59, wherein the data processing unit randomly generates the sounds.

62. An apparatus for presenting a step allowing access to a secure site, comprising
a. a data processing unit connected to at least one key input unit and a display unit
b. said data processing unit is operative to provide a moving visual output on the display unit
c. said display unit provides a place for the user to key in a response based on said output
d. said data processing unit compares said input to the correct answer in the data processing unit's memory to reject or permit logon.

63. The apparatus of claim 62, wherein the data processing unit is operative to distort the moving visual outputs on the display unit.

64. The apparatus of claim 62, wherein the data processing unit randomly generates the moving visual outputs on the display unit.

65. An apparatus of presenting a step allowing access to a secure site, comprising
a. a data processing unit
b. a display unit connected to said data processing unit and displaying a page containing information that requests an input from a user
c. said data processing unit has stored the correct input in its memory, based on previous input by the user, and instructs the display unit to display a request for input of information on the screen, said input apparently requested being dissimilar from the correct input stored in the memory.
d. said display unit is operative to request input from the user based on said information
e. said data processing unit compares said input to the correct answer in the unit's memory to reject or permit logon.

66. An apparatus for presenting a step allowing access to a secure site, comprising
a. a data processing unit, connected to a display unit and an input unit
b. the three said units are operative to perform the following executable action: the user on said units selects on his control panel generated by the data processing unit and displayed on the display unit at least one option for the sequential presentation of a string of pieces of information, said options drawn at least from the group of starting entry point, ending entry point, the number of characters to be entered, the pattern of the characters to be entered, limit of time to enter the input, the timing of the intervals between one piece of presented information and the next, the time allowed for entry of the response after the last required piece of information is presented, the time allowed for entry of the response after the first significant piece of information is presented, string looping, randomization of pieces of information, inclusion of a pattern of nonsense information, visual format of presentation, audio format of presentation, sensory format of presentation, and other parameters of input,
b. the display unit shows information to the user on subsequent log in
c. the entry unit delivers a response from the user to the data processing unit
d. said data processing unit compares said input to the correct answer in the unit's memory to reject or permit logon.

67. The apparatus of claim 66, further comprising:
the data processing unit is operative to perform the timing of the intervals between loops according to previous choices by the user written into the data processing unit's memory.

68. An apparatus for allowing access to a secure site, comprising:
a. a data processing unit connected to a display unit and an input unit
b. said display unit displays a control panel with choices to the user that enable alteration of the level of security
c. a memory on the data processing unit to which user choices are written
d. said display unit is operative to provide choices per previous user instruction when client logs into said account.

69. The apparatus of claim 68, wherein the data processing unit is operative to set other security parameters according to instructions entered from the input unit.

70. The apparatus of claim 68, wherein said display unit is operative to display a choice of at least one verification and one interactive step

71. The apparatus of claim 68, wherein said display unit is operative to display a choice of the number of steps,

72. The apparatus of claim 68, wherein said display unit is operative to display a choice of the randomization of the steps.

73. The apparatus of claim 68, wherein said display unit is operative to display a choice of the order of the steps.

74. The apparatus of claim 68, wherein said display unit is operative to display a choice of the content of each step.

75. The apparatus of claim 68, wherein said display unit is operative to display a choice of a biometric device.

76. The apparatus of claim 75, wherein said display unit is operative to display a choice of an alternate entry apparatus to be made available to the user if the biometric device is not available.

77. The apparatus of claim 68, wherein said display unit is operative to display a choice of breaking up a set of validation steps with at least one interactive step.

78. The apparatus of claim 68, wherein said display unit is operative to display a choice of input prompts for any step.

79. The apparatus of claim 68, wherein said display unit is operative to display the option of permitting only keyboard use for information entry in any step.

80. The apparatus of claim 68, wherein said display unit is operative to display the option of permitting only mouse use for information entry in any step.

81. The apparatus of claim 68, wherein said display unit is operative to display the option of setting the correct input for a step to be different from the displayed value by a fixed formula chosen by the client.

82. The apparatus of claim 68, wherein said display unit is operative to display the option for the user to reconfigure his sign-in options at any time.

83. The apparatus of claim 68, wherein said display unit is operative to display an option for an administrator to set options for sub-accounts.

84. The apparatus of claim 68, wherein said display unit is operative to display a set of choices for the user to manage the parameters of data storage

85. The apparatus of claim 68, wherein said display unit is operative to display a set of choices for the user to manage the parameters of data transfer protection apparatus.

86. The apparatus of claim 68, wherein said display unit is operative to display a choice for access is to a web-based email program.

87. The apparatus of claim 68, wherein said display unit is operative to display a choice for access to a file storage program.

88. The apparatus of claim 68, wherein said display unit is operative to display a choice for access to a shopping cart program.

89. The apparatus of claim 68, wherein said display unit is operative to display a choice for access to a web-based email program and a file storage program.

90. The apparatus of claim 89, wherein said display unit is operative to display a choice for a web-based email program that saves mail to folders on a user's web-based storage space.

91. The apparatus of claim 68, wherein said display unit is operative to display a choice for access to a personal device email program.

92. A apparatus allowing access to a secure site, comprising:
a. a data-processing unit, connected to a display unit and an input unit
b. said display unit is operative to display a control panel to allow the user to set access options
c. computer executable instructions on the data processing unit, operative provide a choice for a biometric device to communicate with the data processing unit
d. computer executable instructions operative to enable the user to set access options temporarily without the biometric device.

93. The apparatus of claim 92, further comprising:
e. said data processing unit is operative to allow the user to log in to his options control panel and elect to add a biometric device to user log in choices
f. a biometric device having a computer-readable serial number
g. said data processing unit is operative to enter the serial number in memory
h. said data processing unit is operative to compare on subsequent log in the serial number in memory and the serial number of the biometric device.

94. The apparatus of claim 92, further comprising:
e. said data processing unit is operative to allow said user to log in to his options panel and elect to add a biometric device to user log in choices
f. said biometric device is operative to read a characteristic of the user
g. said data processing unit is operative to store the characteristic in memory
h. said data processing unit is operative to compare on subsequent log in the characteristic stored in memory with the characteristic read on the device.

95. The apparatus of providing services on a secure site, comprising
a. a data processing unit, a display unit, and an input unit
b. said data processing unit is operative to produce a site where the data of web-based email and file storage are saved in memory to the same virtual directory

96. The apparatus of claim 95, further comprising
c. said data processing unit is operative to enable the user to set up folders in said virtual directory from either the file storage application or the email application.

97. The apparatus of saving email messages, comprising
a. a data processing unit, a display unit, and an input unit
b. computer executable instructions on the data processing unit, said instructions displaying on the display unit the menu option of saving of email messages as at least one format drawn from the group of editable text files, unalterable text files, files of a particular program, Unicode files, and email files.

98. The apparatus of saving email messages, comprising
a. a data processing unit, a display unit, and an input unit
b. computer executable instructions on the data processing unit, said instructions displaying on the display unit the menu option of saving of email messages and attachments simultaneously to the same folder on the data processing unit.
